(19) United States
(12) Patent Application Publication
(10) Pub. No.: US 2026/0279774 A1
(43) Pub. Date: Sep. 17, 2026

(54) ANODE ACTIVE MATERIAL LAYER FOR SODIUM-ION BATTERY, AND SODIUM-ION BATTERY

(71) Applicant: TOYOTA JIDOSHA KABUSHIKI KAISHA, Toyota-shi (JP)

(72) Inventors: Yosuke TOKUDA, Shizuoka-ken (JP); Shin USHIRODA, Shizuoka-ken (JP)

(73) Assignee: TOYOTA JIDOSHA KABUSHIKI KAISHA, Toyota-shi (JP)

(21) Appl. No.: 19/436,032

(22) Filed: Dec. 30, 2025

(30) Foreign Application Priority Data
Mar. 11, 2025 (JP) 2025-038407

(51) Int. Cl. H01M 4/36; H01M 4/02; H01M 4/58; H01M 10/054

(52) U.S. Cl. CPC H01M 4/366; H01M 4/58; H01M 10/054; H01M 2004/027

(57) ABSTRACT

An anode active material layer for a sodium-ion battery, according to the present disclosure, includes a conductive porous layer, and an anode active material borne by the conductive porous layer, in which an amount of the anode active material that is borne varies in a thickness direction of the conductive porous layer. In the conductive porous layer, the amount of the anode active material that is borne in a middle portion in the thickness direction is preferably greater than the amount of the anode active material that is borne in both side portions in the thickness direction.

### CROSS-REFERENCE TO RELATED APPLICATION

This application claims priority to Japanese Patent Application No. 2025-038407 filed on Mar. 11, 2025. The disclosure of the above-identified application, including the specification, drawings, and claims, is incorporated by reference herein in its entirety.

### BACKGROUND

### 1. Technical Field

The present disclosure relates to an anode active material layer for a sodium-ion battery, and the sodium-ion battery.

### 2. Description of Related Art

Japanese Unexamined Patent Application Publication No. 2021-192349 (JP 2021-192349 A) discloses an all-solid-state sodium battery having a cathode layer, an anode layer, and a solid electrolyte layer formed between the cathode layer and the anode layer, in which the anode layer contains a phosphorus-carbon composite as an anode active material.

Japanese Unexamined Patent Application Publication No. 2003-308831 (JP 2003-308831 A) discloses a non-aqueous electrolyte secondary battery including a cathode, an anode, and a non-aqueous electrolyte, in which the anode that is used is an electrode in which a current collector, having a three-dimensional structure, is filled with an anode material containing a composite made of a material containing an element capable of forming an alloy with lithium and a conductive material.

### SUMMARY

When a sodium-ion battery is charged, an anode active material layer expands in some cases. This is due to anode active material used in the sodium-ion battery intercalating sodium ions and expanding.

An object of the present disclosure is to provide an anode active material layer that is suppressed from expanding when a sodium-ion battery is charged.

The present disclosers have found that the above object can be achieved by the following means.

### Aspect 1

An anode active material layer for a sodium-ion battery, the anode active material layer including
a conductive porous layer, and
an anode active material borne by the conductive porous layer, in which
an amount of the anode active material that is borne varies in a thickness direction of the conductive porous layer.

### Aspect 2

The anode active material layer according to Aspect 1, in which, in the conductive porous layer, the amount of the anode active material that is borne in a middle portion in the thickness direction is greater than the amount of the anode active material that is borne in both side portions in the thickness direction.

### Aspect 3

The anode active material layer according to Aspect 1, in which the conductive porous layer includes at least a first layer, a second layer, and a third layer, in this order in the thickness direction, and the amount of the anode active material that the second layer bears is greater than the amount of the anode active material that the first layer and the third layer bear.

### Aspect 4

The anode active material layer according to Aspect 1, wherein the anode active material contains phosphorus.

### Aspect 5

A sodium-ion battery including the anode active material layer according to any one of Aspects 1 to 4, an electrolyte layer, and a cathode active material layer that are in this order.

According to the present disclosure, an anode active material layer that is suppressed from expanding when a sodium ion battery is charged can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an anode active material layer 10 according to an embodiment of the present disclosure; and

FIG. 2 is a schematic diagram of a sodium-ion battery 100 according to the embodiment of the present disclosure.

### DETAILED DESCRIPTION OF EMBODIMENTS

An embodiment of the present disclosure will be described below in detail. Note that the present disclosure is not limited to the following embodiment, and can be carried out modified variously, within the spirit and scope of the disclosure.

### 1. Anode Active Material Layer for Sodium-Ion Battery

An anode active material layer for a sodium-ion battery according to the present disclosure (hereinafter simply referred to as the “anode active material layer according to the present disclosure”) has a conductive porous layer, and an anode active material borne in the conductive porous layer, in which the amount of anode active material that is borne varies in a thickness direction of the conductive porous layer.

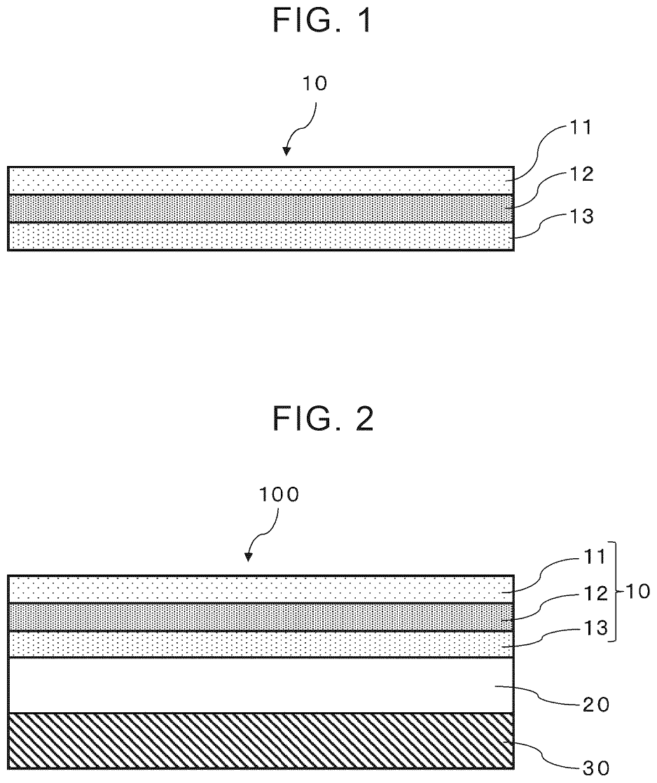

FIG. 1 is a schematic diagram of an anode active material layer 10 according to the embodiment of the present disclosure. As illustrated in FIG. 1, the anode active material layer 10 has at least a first layer 11, a second layer 12, and a third layer 13 arrayed in this order in the thickness direction. The amount of anode active material borne in each layer varies thereamong. In the embodiment of FIG. 1, the anode active material layer 10 is made by laminating the first layer 11, the second layer 12, and the third layer 13 in this order. However, the anode active material layer 10 may be formed from a single layer. The anode active material layer 10 may be configured by laminating even more layers than three layers.

The anode active material used in sodium-ion batteries expands in some cases when the battery is charged. Expansion of the anode active material can lead to expansion of the anode active material layer. A conceivable method for suppressing the expansion of the anode active material layer is to reduce the amount of anode active material borne by the metal porous layer. It is conceivable that reducing the amount of anode active material borne by the metal porous layer will result in the metal porous layer having more voids, and accordingly the voids will be able to absorb the expansion of the anode active material.

However, reducing the amount of anode active material borne by the metal porous layer will reduce volumetric energy density of the anode active material layer.

In the anode active material layer according to the present disclosure, the amount of anode active material that is borne varies in the thickness direction of the conductive porous layer. This enables expansion of the anode active material layer due to the expansion of the anode active material during charging to be suppressed, without reducing the volumetric energy density of the anode active material layer. Specifically, in the anode active material layer according to the present disclosure, the anode active material is not uniformly borne in the conductive porous layer, and accordingly expansion in portions of the anode active material layer where the amount of anode active material that is borne is great can be absorbed by portions where the amount of anode active material that is borne is small.

### 1-1. Conductive Porous Layer

The conductive porous layer is a layer of a porous material that has electrical conductivity.

In the conductive porous layer, the amount of anode active material that is borne in a middle portion in the thickness direction is preferably greater than the amount of anode active material that is borne in both side portions in the thickness direction. This is because when a great amount of anode active material is borne in the central portion in the thickness direction, the expansion of the anode active material in that portion can be absorbed by both sides thereof in the thickness direction where the amount of anode active material that is borne is small. This can further suppress expansion of the anode active material layer during charging.

The conductive porous layer can have at least a first layer, a second layer, and a third layer, arrayed in this order in the thickness direction. By laminating the layers having different amounts of anode active material borne thereby on each other, the amount of anode active material borne by the conductive porous layer can be easily varied in the thickness direction. In this case, the amount of anode active material borne in the second layer is preferably greater than the amounts of anode active material borne in the first layer and the third layer.

Examples of porous materials that have electrical conductivity include stainless steel, aluminum, nickel, iron, titanium, carbon, and so forth. The conductive porous layer may be, for example, a nonwoven fabric or a mesh.

The porosity of the conductive porous layer may be 50% to 95%. The porosity may be 50% or more, 55% or more, 60% or more, 65% or more, or 70% or more. The porosity may be 95% or less, 90% or less, 85% or less, or 80% or less. In particular, when the porosity is 50% or more, the amount of anode active material that is borne can be increased, and also the expansion of the anode active material during charging can be more readily absorbed.

The thickness of the conductive porous layer may be 50 μm to 500 μm. The thickness may be 50 μm or more, 100 μm or more, 150 μm or more, or 200 μm or more. The thickness may be 500 μm or less, 450 μm or less, 400 μm or less, or 350 μm or less.

### 1-2. Anode Active Material

The anode active material according to the present disclosure is anode active material used in the sodium-ion battery. The anode active material preferably contains phosphorus. This is because anode active materials containing phosphorus expand particularly greatly during charging.

An example of an anode active material containing phosphorus is a phosphorus-carbon composite. Here, the “phosphorus-carbon composite” is a substance in which phosphorus (P) and carbon (C) are present in a dispersed state. The phosphorus (P) and the carbon (C) are preferably dispersed in nanometer order. Also, the phosphorus (P) and the carbon (C) may be compounded, or may be a solid solution of one element as to a structure of the other element. The phosphorus-carbon composite may also be a substance obtained by mechanical milling of a raw material composition containing the phosphorus (P) and the carbon (C).

The phosphorus-carbon composite may have just the phosphorus (P) and the carbon (C), or may further contain another element. An example of another element is a metal element that is capable of ion conduction. Examples of metal elements capable of ion conduction include Na and Li. The number of types of metal elements capable of ion conduction may be one type, or may be two or more types. The phosphorus-carbon composite may further include other elements, such as, for example, boron (B), oxygen (O), sulfur(S), and/or halogens (X). Examples of halogens (X) include Cl, Br, and I. The number of types of halogens may be one type, or may be two or more types.

The anode active material is preferably particulate. When the anode active material is particulate, the average particle size (D50) thereof is, for example, 100 μm or less, and may be 30 μm or less. The average particle size (D50) can be found by observation using a scanning electron microscope (SEM), for example. The number of samples is preferably great, such as 100 or more, for example.

### 2. Sodium-Ion Battery

The sodium-ion battery according to the present disclosure has the anode active material layer for the sodium ion battery according to the present disclosure, a solid electrolyte layer or a separator, and a cathode active material layer, in this order.

The sodium-ion battery according to the present disclosure may be an aqueous sodium-ion battery, a non-aqueous sodium-ion battery, or an all-solid-state sodium-ion battery.

FIG. 2 is a schematic diagram of a sodium-ion battery 100 according to the embodiment of the present disclosure. As illustrated in FIG. 2, the sodium-ion battery 100 has the anode active material layer 10 according to the present disclosure, an electrolyte layer 20, and a cathode active material layer 30, in this order. Although omitted from illustration, an anode current collector layer can further be disposed on a face of the anode active material layer 10 opposite to a face on which the electrolyte layer 20 is disposed. Although omitted from illustration, a cathode current collector layer can be further disposed on a face of the cathode active material layer 30 opposite to a face on which the electrolyte layer 20 is disposed.

### 2-1. Electrolyte Layer

The electrolyte layer 20 is a layer that is formed between the anode active material layer 10 and the cathode active material layer 30. The electrolyte layer 20 enables ionic conduction between the cathode active material and the anode active material via an electrolyte contained therein. The form of the electrolyte layer 20 is not limited in particular, and examples thereof can include a liquid electrolyte layer, a gel electrolyte layer, and a solid electrolyte layer.

The liquid electrolyte layer is typically a layer made using a non-aqueous electrolyte solution. The non-aqueous electrolyte typically contains a sodium salt and a non-aqueous solvent. Examples of sodium salts include inorganic sodium salts such as NaPF₆, NaBF₄, NaClO₄, NaAsF₆, and so forth; and organic sodium salts such as NaCF₃SO₃, NaN(CF₃SO₂)₂, NaN(C₂FsSO₂)₂, NaN(FSO₂)₂, NaC(CF₃SO₂)₃, and so forth.

The non-aqueous solvent is not limited in particular, as long as the sodium salt is dissolved therein. Examples of high dielectric constant solvents include cyclic esters (cyclic carbonates) such as ethylene carbonate (EC), propylene carbonate (PC), butylene carbonate (BC), and so forth, and γ-butyrolactone, sulfolane, N-methylpyrrolidone (NMP), 1,3-dimethyl-2-imidazolidinone (DMI), and so forth. On the other hand, examples of low-viscosity solvents include linear esters (linear carbonates) such as dimethyl carbonate (DMC), diethyl carbonate (DEC), ethyl methyl carbonate (EMC), and so forth, acetates such as methyl acetate and ethyl acetate, and so forth, and ethers such as 2-methyltetrahydrofuran, and so forth. A mixed solvent, in which a high dielectric constant solvent and a low viscosity solvent are mixed, may also be used.

The concentration of the sodium salt in the non-aqueous electrolyte solution is, for example, in a range of 0.3 mol/L to 5 mol/L, and preferably in a range of 0.8 mol/L to 1.5 mol/L. This is because when the concentration of the sodium salt is too low, there is a possibility that the capacity will decrease at high rates, and when the concentration of the sodium salt is too high, there is a possibility that the viscosity will increase, resulting in a decrease in capacity at low temperatures. Note that a low-volatility liquid such as an ionic liquid or the like, for example, may be used as the non-aqueous electrolyte.

The gel electrolyte layer can be obtained by adding a polymer to a non-aqueous electrolyte solution to form a gel, for example. Specifically, gelation can be achieved by adding a polymer such as polyethylene oxide (PEO), polyacrylonitrile (PAN), polymethyl methacrylate (PMMA), or the like, to the non-aqueous electrolyte.

The solid electrolyte layer is a layer made of a solid electrolyte. The solid electrolyte is not limited in particular as long as it has Na ion conductivity, and examples thereof include a NaMH compound, known oxide solid electrolytes, sulfide solid electrolytes, and so forth.

### 2-2. Cathode Active Material Layer

The cathode active material layer 30 contains at least a cathode active material. Further, a conductive material, a binder, and a solid electrolyte can be optionally contained. These materials may be those typically used in sodium-ion batteries.

### 2-3. Current Collector Layer

In the cathode active material layer 30, a cathode current collector is usually disposed on the face of the cathode active material layer 30 that is not on the electrolyte layer 20 side. Examples of materials for the cathode current collector include stainless steel, aluminum, nickel, iron, titanium, carbon, and so forth. Examples of the form of the cathode current collector include forms such as a foil, a mesh, a porous material, or the like. A cathode can be easily produced by laminating the cathode current collector on the above-described cathode active material layer. However, depending on the material contained in the cathode active material layer, the cathode current collector may be omitted. In this case, the cathode active material layer 30 itself serves as the cathode.

The anode active material layer 10 is usually provided with an anode current collector on the face of the anode active material layer 10 that is not on the electrolyte layer 20 side. Examples of materials for the anode current collector include stainless steel, aluminum, nickel, copper, carbon, and so forth. Examples of the form of the anode current collector include forms such as a foil, a mesh, a porous material, or the like. An anode can be easily produced by laminating the anode current collector on the above-described anode active material layer. However, the anode current collector may be omitted, since the anode active material layer of the present disclosure has the conductive porous layer.

### 2-3. Other Configurations

A battery case used for the sodium-ion battery 100 can be any general battery case and is not limited in particular. Also, the sodium-ion battery 100 may be a primary battery or a secondary battery, but is preferably a secondary battery, in order to more effectively exhibit advantages of improved durability.

### 3. Examples 1 to 5 and Comparative Examples 1 to 4

### 3-1. Comparative Example 1

Red phosphorus (Japan Pure Chemical) and acetylene black (Li-400, DENKA) were used as raw materials, and were weighed out to a total of 5 g in a mass ratio of 7:3. After mixing in a mortar, the mixture was placed in a ball mill pot together with 96 g of 5-mm diameter zirconia balls, and after replacing the atmosphere with Ar gas, the pot was sealed and subjected to ball milling to prepare a phosphorus-carbon composite material as an anode active material. The ball milling conditions were 500 rpm for 24 hours.

The anode active material, carbon nanotubes, and polyvinylidene fluoride (PVDF) were weighed out in a mass ratio of 93:1:6, and dispersed and mixed in N-methyl-2-pyrrolidone as an organic solvent to form a slurry. A copper nonwoven fabric (porosity 83%, thickness 210 μm) was used as the conductive porous layer, and the slurry was applied thereto. After drying, the mixture was pressed to a thickness of 200 μm and vacuum dried overnight at 120° C. to obtain an anode active material layer. The coating weight of the anode active material was 5 mg/cm².

The anode active material layer that was produced was evaluated using a CR2032 type coin cell, as follows.

A metallic sodium foil was used as a counter electrode. The electrolytic solution that was used was 1M NaPF₆ (EC:DEC=1:1 vol, FEC 3 wt %). The evaluation was carried out in a thermostatic chamber at 25° C., with a voltage range of 0.01 to 2.0 V and a rate of 0.1 C. The battery capacity was calculated based on the mass of phosphorus in the electrode. In this experiment, a reaction in which phosphorus exhibits intercalation of sodium is referred to as charging.

The thickness of the anode active material layer before and after the initial charge was measured with a constant pressure thickness gauge (Teclock, PG-15A), and the coefficient of expansion of the anode active material layer was calculated. The results are shown in Table 1.

### 3-2. Comparative Example 2

The anode active material prepared in the same way as in Comparative Example 1 was similarly made into a slurry, which was then applied to three sheets of copper nonwoven fabric that were laid upon each other. The anode active material was evenly borne by each of the sheets of nonwoven fabric. The anode active material layer was pressed to a thickness of 400 μm. The coating weight of the anode active material was 10 mg/cm². The coefficient of expansion of the anode active material layer was calculated in the same way as that in Comparative Example 1. The results are shown in Table 1 in “3-7. Results”.

### 3-3. Comparative Example 3

The coefficient of expansion of the anode active material layer was calculated in the same way as in Comparative Example 1, except that an aluminum mesh was used instead of the copper nonwoven fabric. The results are shown in Table 1 in “3-7. Results”.

### 3-4. Comparative Example 4

The anode active material prepared in the same way as that in Comparative Example 1 was similarly made into a slurry, which was then applied to a copper current collector foil. After drying, the mixture was pressed to a thickness of 15 μm (excluding the copper foil) and vacuum dried at 120° C. overnight to form an anode active material layer on the copper current collector foil. The coefficient of expansion of the anode active material layer was calculated in the same way as that in Comparative Example 1. The results are shown in Table 1 in “3-7. Results”.

### 3-5. Examples 1 to 4

The slurry of the anode active material was applied to three sheets of copper nonwoven fabric such that the coating weight of each was as shown in Table 1. Thereafter, three sheets of copper nonwoven fabric were laminated to form an anode active material layer. The coefficient of expansion of the anode active material layer was calculated in the same way as that in Comparative Example 1. The results are shown in Table 1 in “3-7. Results”.

### 3-6. Example 5

The slurry of the anode active material was applied to one of three sheets of aluminum mesh. The coating weight of the anode active material was as shown in Table 1.

The three sheets of aluminum mesh were laminated such that the aluminum mesh coated with the anode active material was in the middle, to form an anode active material layer. The coefficient of expansion of the anode active material layer was calculated in the same way as that in Comparative Example 1. The results are shown in Table 1 in “3-7. Results”.

### 3-7. Results

Relation between manufacturing conditions and the coefficient of expansion of the anode active material layer in each example is shown in Table 1 below. In Table 1, “electrode material” indicates the material of the conductive porous layer or the current collector. The coating weights of the anode active material are referred to as the first layer, the second layer, and the third layer, in order from the counter electrode side. The coefficient of expansion is a value obtained by dividing the thickness of the anode active material layer after charging by the thickness of the anode active material layer before charging.

TABLE 1

| | | | Coating weight of anode | | | | |
|---|---|---|---|---|---|---|---|
| | | Specific capacity | active material (mg/cm²) | | | | Coefficient |
| | Electrode | at initial charge | | First | Second | Third | of |
| | material | (mAh/g) | Total | layer | layer | layer | expansion |
| Comparative | Cu | 1958 | 5.0 | 5.0 | — | — | 2.35 |
| Example 1 | | | | | | | |
| Comparative | Cu | 1969 | 10.0 | 3.3 | 3.3 | 3.3 | 1.92 |
| Example 2 | | | | | | | |
| Comparative | Al | 1981 | 5.0 | 5.0 | — | — | 2.37 |
| Example 3 | | | | | | | |
| Comparative | Cu foil | 1961 | 1.0 | 1.0 | — | — | 5.00 |
| Example 4 | | | | | | | |
| Example 1 | Cu | 1978 | 10.0 | 2.0 | 6.0 | 2.0 | 1.46 |
| Example 2 | Cu | 1997 | 10.0 | 3.0 | 4.0 | 3.0 | 1.53 |
| Example 3 | Cu | 1989 | 10.0 | 1.0 | 3.0 | 6.0 | 1.76 |
| Example 4 | Cu | 2001 | 10.0 | 6.0 | 3.0 | 1.0 | 1.65 |
| Example 5 | Al | 1982 | 10.0 | 0.0 | 10.0 | 0.0 | 1.61 |

Unlike Comparative Example 2 in which the anode active material was uniformly borne within the structure, Examples 1 to 5 laminated three conductive porous layers to provide a difference in the amount of anode active material borne in the thickness direction of the anode active material layer, thereby enabling mitigation of expansion of the anode active material layer during charging.

In particular, in the examples in which the amount of anode active material borne by the second layer was great, that is, in Examples 1, 2, and 5, the effect of suppressing expansion was particularly great. It is conceivable that the expansion of the anode active material layer was absorbed by the first layer and the third layer, which bore a small amount of anode active material, and the voids in the anode active material layer were effectively utilized, thereby suppressing the coefficient of expansion.

What is claimed is:

1. An anode active material layer for a sodium-ion battery, the anode active material layer comprising:
a conductive porous layer; and
an anode active material borne by the conductive porous layer, wherein
an amount of the anode active material that is borne varies in a thickness direction of the conductive porous layer.

2. The anode active material layer according to claim 1, wherein, in the conductive porous layer, the amount of the anode active material that is borne in a middle portion in the thickness direction is greater than the amount of the anode active material that is borne in both side portions in the thickness direction.

3. The anode active material layer according to claim 1, wherein the conductive porous layer includes at least a first layer, a second layer, and a third layer, in this order in the thickness direction, and the amount of the anode active material that the second layer bears is greater than the amount of the anode active material that the first layer and the third layer bear.

4. The anode active material layer according to claim 1, wherein the anode active material is phosphorus.

5. A sodium-ion battery comprising
the anode active material layer according to claim 1; an electrolyte layer; and a cathode active material layer that are in this order.
